(19) United States
(12) Patent Application Publication
(10) Pub. No.: US 2025/0216923 A1
(43) Pub. Date: Jul. 3, 2025

(54) Quality of Service (QoS) Management for Real-Time and Best-Effort Clients Using Power Management Policies

(71) Applicant: Advanced Micro Devices, Inc., Santa Clara, CA (US)

(72) Inventors: Wonje Choi, Austin, TX (US); Kunal Chetan Sheth, Austin, TX (US); Indrani Paul, Austin, TX (US); Adam Neil Calder Clark, Victoria (CA); Shilpa Rajagopalan, North York (CA); Tung Chuen Kwong, Richmond Hill (CA); King Chiu Tam, Vaughan (CA)

(73) Assignee: Advanced Micro Devices, Inc., Santa Clara, CA (US)

(21) Appl. No.: 18/898,646

(22) Filed: Sep. 26, 2024

Related U.S. Application Data
(60) Provisional application No. 63/560,928, filed on Mar. 4, 2024.
(60) Provisional application No. 63/617,318, filed on Jan. 3, 2024.

(51) Int. Cl. G06F 1/3234; G06N 5/04

(52) U.S. Cl. CPC G06F 1/3234; G06N 5/04

(57) ABSTRACT

A power manager of an apparatus exposes an application programming interface (API) usable to specify priority and quality-of-service (QoS) parameters (e.g., latency, throughput) for a workload. An application, for instance, specifies the priority and QoS parameters for a workload to be processed using a hardware compute unit. The priority and QoS parameters are employed by the power manager as a basis to configure the power setting of a hardware compute unit. In particular, resource prioritization is extended to both real-time and best-effort workloads to satisfy specified QoS parameters for inference workloads.

### BACKGROUND

Inference models (e.g., machine-learning and trained artificial intelligence (AI) models) are increasingly used to improve task accuracy and efficiency. The speed of inference models generally depends on a combination of hardware, software, and middleware. To this point, processing units (e.g., inference processing units (IPUs), neural network engines (NNEs), and accelerator processing units (APUs)) optimized for inference models have become more prevalent. Such processing units, however, are generally implemented in devices that employ power management policies to conserve power but often result in fewer resources being available to these processing units, causing slower inference models and degraded user experience.

### BRIEF DESCRIPTION OF THE DRAWINGS

The detailed description is described with reference to the accompanying figures.

FIG. 1 is a block diagram of a non-limiting example of a device configured to implement QoS management for real-time and best-effort inference models using power management policies.

FIG. 2 is a block diagram of a non-limiting example showing the operation of a power manager to implement QoS management for real-time and best-effort inference models using power management policies and techniques.

FIG. 3 is a block diagram of a non-limiting example of a system showing the operation of a power manager and hardware driver to implement QoS management for inference models using power management policies.

FIG. 4 is a block diagram of a non-limiting example of a framework for QoS management for real-time and best-effort inference models using power management policies.

FIG. 5 depicts a procedure for QoS management of real-time and best-effort inference models using power management policies.

FIG. 6 is a block diagram of a processing system configured to execute one or more applications in accordance with one or more implementations.

### DETAILED DESCRIPTION

The hardware design of processors continually evolves to provide ever-increasing amounts and varieties of functionality in support of corresponding increases in application functionality. For example, processors and processor cores have increased computational power to address the increasing demand for inference and other machine-learning applications. As a result, managing the resources allocated for executing workloads (e.g., inference and AI workloads) from the clients or applications using various hardware designs and operating policies has also experienced a corresponding increase in complexity, sometimes hindering device operation. For example, a priority parameter is used to differentiate between real-time and non-real-time (e.g., normal priority or best-effort) workloads. In real-world scenarios, applications typically default to identifying as “real-time” workloads, which results in multiple workload requests causing performance or efficiency degradation. In another example, high-level hints are used to indicate desired modes of operation but do not provide insight into actual resource utilization and processing goals for a corresponding workload. This often results in inefficient resource allocation, a corresponding increase in power consumption, and thus inefficient operation of devices that utilize these resources.

To solve these problems, a power manager of a client (e.g., an inference accelerator) exposes an application programming interface (API) to applications to specify priority and QoS parameters (e.g., latency, throughput, deadline, computational time). A client, for instance, specifies the QoS parameters for processing a workload using a hardware compute unit. In an example involving image processing, the priority parameter identifies the workload as “real-time,” and the QoS parameters specify a processing rate of thirty frames per second with a thirty-millisecond latency for use in object recognition by a machine-learning or AI model executed by the hardware compute unit.

The power manager employs the priority and QoS parameters to configure clock speeds or operating voltages of a processor unit, e.g., a system-on-chip (SoC) with multiple processor cores, one of which is employed to implement the machine-learning model. The clock speeds or operating voltages are configured such that the processing resources available for the workload comply with the QoS parameters. The power manager, for instance, configures a partition to have sufficient processing resources (e.g., clock speed to implement a machine-learning model) to support the QoS parameters. This improves device operation through targeted optimization of computational resources and reduces power consumption.

Other insights are also usable by the power manager to handle inference workloads and satisfy corresponding priority and QoS parameters. In one example, workload statistics are obtained that describe processing characteristics for the workload (e.g., the number of operations to be performed and data movement between layers of a machine-learning model). The workload statistics, for instance, are obtained from heuristics generated from prior knowledge of hardware and/or firmware for the machine-learning model.

In another example, the power manager employs operation data to set power settings. The operation data for a hardware compute unit includes resource consumption by other partitions, partition availability, temperature, or power usage. In this way, the power manager optimizes the operation of the hardware compute unit based on insight gained into a workload to be processed.

In yet another example, the power manager determines potential power settings or sets a power setting for a particular workload based on power modes (e.g., power-slider position, power source). For example, a “best battery” or “best efficiency” power-slider position or power mode limits the type of power settings available.

In some aspects, the techniques described herein relate to a device comprising a power manager configured to: expose an application programming interface to an application to specify a priority parameter and a quality-of-service (QoS) parameter for processing a workload, and configure a hardware compute unit of the device to process the workload at a first power setting among multiple power settings based at least in part on the priority parameter and the QoS parameter.

In some aspects, the techniques described herein relate to a device wherein the power manager is further configured to: in response to the priority parameter indicating a real-time priority and the QoS parameter specifying a latency or throughput for the workload, assign a hard-minimum power setting associated with the workload that ensures the QoS parameter is satisfied, or in response to the priority parameter indicating a best-effort priority, the QoS parameter specifying a latency or throughput for the workload, and a power-mode setting being satisfied by the hardware compute unit, assign a soft-minimum power setting associated with the workload that ensures the QoS parameter is satisfied.

In some aspects, the techniques described herein relate to a device wherein the power-mode setting is based on: whether the device is powered by alternating-current (AC) power or direct-current (DC) power, or a power-slider position for the hardware compute unit, the power-slider position including at least two of a best power efficiency setting, one or more balanced power efficiency and performance settings, or a best performance setting.

In some aspects, the techniques described herein relate to a device wherein the power manager is further configured to throttle other hardware compute units of the device in response to the power setting selected to satisfy the QoS parameter under the hard-minimum power setting consuming more power than a potential power setting selected based on the power-mode setting.

In some aspects, the techniques described herein relate to a device wherein the power manager is further configured to throttle the hardware compute unit in response to the power setting selected to satisfy the QoS parameter under the soft-minimum power setting consuming more power than a potential power setting selected based on the power-mode setting.

In some aspects, the techniques described herein relate to a device wherein the power manager is further configured to, in response to the application not specifying the QoS parameter, assign no minimum power setting associated with the workload and determine the first power setting based on the power-mode setting.

In some aspects, the techniques described herein relate to a device wherein the power manager is further configured to receive operation data that describes operation characteristics of the hardware compute unit and determine the first power setting based at least in part on the priority parameter, the QoS parameter, and the operation data.

In some aspects, the techniques described herein relate to a method comprising: receiving an input via an application programming interface (API) from an application, the input specifying a priority parameter for processing a workload associated with the application, selecting, based at least in part on the priority parameter, a first power setting from among multiple power settings to process the workload, each power setting of the multiple power settings identifying a voltage and a frequency at which to operate a hardware compute unit, and processing the workload from the application by the hardware compute unit at the first power setting.

In some aspects, the techniques described herein relate to a method wherein the priority parameter indicates the workload has a real-time priority, priority-band, or best-effort priority.

In some aspects, the techniques described herein relate to a method wherein the method further comprises: in response to the priority parameter indicating the real-time priority and the input also specifying a quality-of-service (QoS) parameter for the workload, selecting a second power setting from among the multiple power settings to process the workload that satisfies the QoS parameter, in response to the priority parameter indicating the best-effort priority and the input also specifying the QoS parameter for the workload, selecting a third power setting to process the workload that satisfies the QoS parameter or a power mode of the hardware compute unit, or in response to the input not specifying the QoS parameter for the workload, selecting a fourth power setting that satisfies the power mode.

In some aspects, the techniques described herein relate to a method wherein: in response to a power-mode-based power setting consuming more power than a QoS-based power setting, the QoS-based power setting is selected as the third power setting, or in response to the QoS-based power setting consuming more power than the power-mode-based power setting, the power-mode-based power setting is selected as the third power setting.

In some aspects, the techniques described herein relate to a method wherein: the multiple power settings are arranged in a power-level table by descending amounts of power consumption per power setting; and potential power settings available in the power-level table are determined at least in part by the power mode of the hardware compute unit.

In some aspects, the techniques described herein relate to a method wherein: the method further comprises receiving workload statistics describing the workload; and selecting the first power setting is based at least in part on the priority parameter and the workload statistics.

In some aspects, the techniques described herein relate to a method wherein the workload statistics specify a number of operations or amount of data movement.

In some aspects, the techniques described herein relate to a method wherein the workload statistics are determined based on prior knowledge of processing the workload.

In some aspects, the techniques described herein relate to a method wherein the workload includes execution of a machine-learning model selected from a plurality of precompiled machine-learning models.

In some aspects, the techniques described herein relate to a method wherein: the method further comprises receiving operation data that describes operating characteristics of the hardware compute unit; and selecting the first power setting is based at least in part on the priority parameter and the operation data.

In some aspects, the techniques described herein relate to a method wherein the operation data comprises operation characteristics of another partition of the hardware compute unit.

In some aspects, the techniques described herein relate to a method comprising: receiving an input from an application that specifies a priority parameter, a quality-of-service (QoS) parameter, and workload statistics for processing a workload, selecting a power setting of a hardware compute unit to process the workload, the power setting determined to minimize power consumption in processing the workload and based at least in part on the workload statistics, the priority parameter, and the QoS parameter, generating a partition in the hardware compute unit based on the power setting, and processing the workload from the application using the generated partition by the hardware compute unit.

In some aspects, the techniques described herein relate to a method wherein the method further comprises: in response to the priority parameter indicating a real-time priority and the QoS parameter being specified, selecting the power setting to ensure satisfaction of the QoS parameter, in response to the priority parameter indicating a best-effort priority and the QoS parameter being specified, selecting the power setting to ensure satisfaction of the QoS parameter or compliance with a power-mode setting associated with the hardware compute unit, or in response to the QoS parameter not being specified, selecting the power setting to ensure compliance with the power-mode setting.

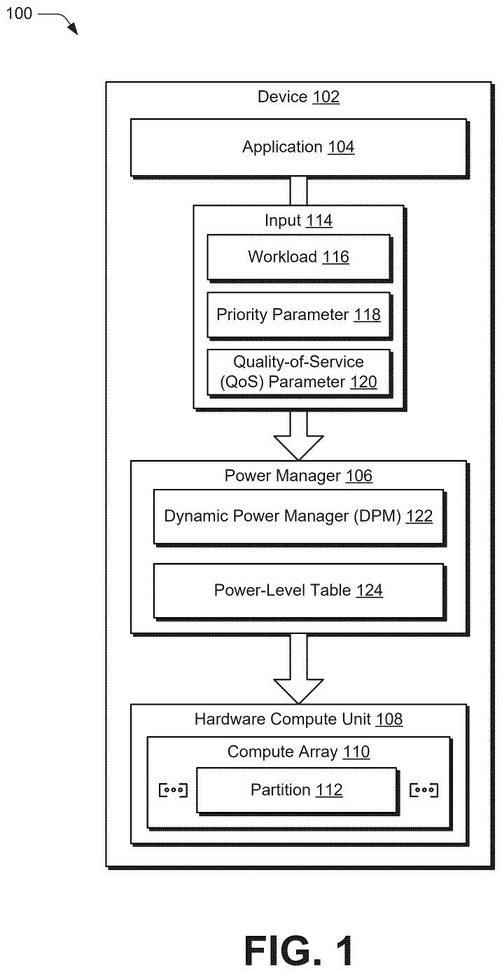

FIG. 1 is a block diagram of a non-limiting example 100 of a device 102 configured to implement quality of service (QoS) management for inference models and other clients using power management policies. These techniques are usable by a wide range of device 102 configurations. Examples of those devices include, by way of example and not limitation, computing devices, servers, mobile devices (e.g., wearables, mobile phones, tablets, laptops), processors (e.g., graphics processing units, central processing units, and accelerators), digital signal processors, interference accelerators, disk array controllers, hard disk drive host adapters, memory cards, solid-state drives, wireless communications hardware connections, Ethernet hardware connections, switches, bridges, network interface controllers, mobile phones, tablets and other apparatus configurations. In various implementations, the techniques described herein are usable using any one or more of those devices listed above and/or a variety of other devices without departing from the spirit or scope of the described techniques.

The illustrated example of the device 102 includes an application 104, power manager 106, and hardware compute unit 108. The application 104 represents any form of software configurable as instructions that are executable by a processing device (e.g., central processing unit, parallel processing unit, etc.) to perform operations. In some implementations, the application 104 employs machine-learning and other inference models to perform a compute task (e.g., image processing).

The power manager 106 is representative of functionality to select a power setting and control power (e.g., voltage or frequency) allocated for execution of the code to perform operations by the hardware compute unit 108. The application 104, for instance, is executable by a central processing unit (CPU). The hardware compute unit 108 is configurable as a system-on-a-chip (SoC), parallel processor (e.g., graphics processing unit, inference processor), and so forth. The application 104 and hardware compute unit 108 are communicatively coupled, e.g., via a bus.

In the illustrated example, the hardware compute unit 108 is configured as a compute array 110 with individually powered and clocked circuitry. By leveraging this functionality, partitions 112 are formable in the hardware compute unit 108 as hardware dedicated to a particular function, e.g., to separate execution of instructions from multiple applications. To do so, the power manager 106 specifies the configuration of the partition 112 in the hardware compute unit 108. Such configuration includes a variety of functionalities, including the ability to specify particular hardware, amount of processing resources, clock speeds, operating voltages, and so forth to be used in executing the instructions.

The power manager 106 receives an input 114 from an application 104. The input 114 specifies a workload 116 (e.g., collection of instructions, data, and so forth). In response, the power manager 106 configures a partition 112 in the compute array 110 to process the workload 116, with the result thereof returned to the application 104.

The input 114 also specifies a priority parameter 118 and a quality-of-service (QoS) parameter 120 associated with the workload 116. The priority parameter 118 allows application 104 to indicate the priority of the workload 116. For example, the priority parameter 118 indicates a real-time, priority (or priority band), or best-effort (e.g., normal) priority states for the workload. In other implementations, the priority parameter may include additional priority states. The QoS parameter 120 indicates a throughput, deadline, or latency required for workload 116.

Conventional power management techniques prioritize the completion of workloads that indicate a real-time priority and specify at least one QoS parameter. All other workloads (e.g., no QoS parameters specified or best-effort priority) are not given resource prioritization. In other words, real-time workloads are guaranteed resources (e.g., voltage and frequency) to satisfy the specified QoS parameters. Priority-band or best-effort workloads, however, do not receive resource guarantees and are subject to resource contention and power throttling. As a result, priority-band and best-effort workloads are assigned a default power setting and may not satisfy QoS parameters.

In contrast, the described techniques and systems extend power management policies to priority-band and best-effort workloads. The power manager 106 utilizes a dynamic power manager (DPM) 122 that enables the application 104 to specify a QoS parameter 120 for processing the workload 116 for real-time, priority-band, and best-effort priorities. As with conventional techniques, if the priority parameter 118 associated with the workload 116 indicates real-time priority with at least one QoS parameter 120 specified, then the workload 116 is assigned to the real-time class within the partition 112 and prioritized for resource or power allocation. The power manager 106 also extends dynamic power management to priority-band and best-effort workloads if at least one QoS parameter 120 is specified. This allows such workloads to be assigned QoS-derived power settings within a power-level table 124, which indicates a descending order of power settings with associated frequency and voltage settings.

The power manager 106 then uses the assigned power setting (from among the power-level table 124) to process the workload 116. In particular, a partition 112 of the compute array 110 is configured to comply with these parameters, e.g., to provide sufficient processing resources from the compute array 110 such that processing of the workload 116 is performed as having the specified QoS. In this way, the power manager 106 configures the partition 112 or the hardware compute unit 108 to minimize power consumption in a manner that provides a desired amount of functionality as specified by the application 104 using the priority parameter 118 and QoS parameter 120, thereby optimizing the operation of the device 102 and extending dynamic power management policies to priority-band and best-effort (inference) workloads.

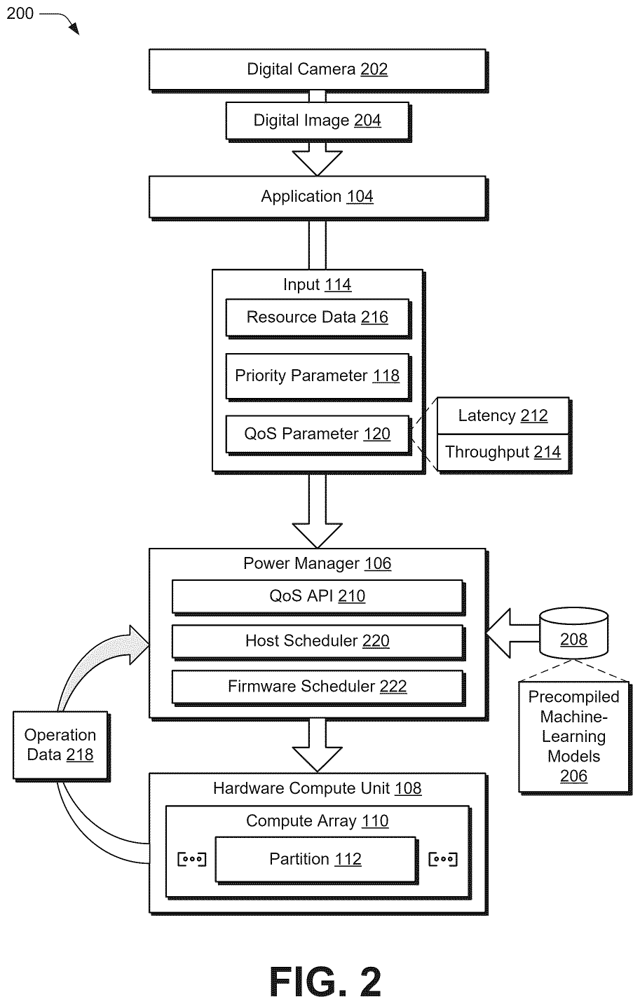

FIG. 2 is a block diagram of a non-limiting example 200 showing the operation of a power manager to implement QoS management for real-time, priority-band, and best-effort inference models using power management policies and techniques. In this example, the device 102 of FIG. 1 includes a digital camera 202 configured to capture digital images 204 (e.g., photos or videos). The application 104 is then configured to leverage a machine-learning model to process the digital image 204, e.g., to perform object recognition, image correction, background blurring, and so forth.

To do so, the application 104 provides an input 114 to the power manager 106 to configure the hardware compute unit 108, compute array 110, and/or partition 112 to implement the machine-learning model using a selected one of a plurality of precompiled machine-learning models 206 illustrated as available via storage 208. The input 114 includes a priority parameter 118 and QoS parameter 120 provided via a QoS API 210. Examples of the QoS parameter 120 include latency 212 and throughput 214. For processing digital image 204, the priority parameter 118 specifies whether the workload is to be processed in “real-time,” “priority band” (e.g., balance between performance and power efficiency), or “not real-time” (i.e., “best effort” or “normal”). The QoS parameters 120 include the throughput 214 (e.g., a framerate of thirty frames-per-second) and the latency 212 permitted for processing the workload (e.g., thirty milliseconds latency).

Input 114 in this example also includes resource data 216, which provides insights into the resources required for processing the workload 116. The workload 116 in this example is deterministic, and by leveraging this, the resource data 216 includes workload statistics that are determined and characterized during a compilation stage in generating the precompiled machine-learning models 206. The workload statistics are configurable as a serialized graph representation that describes resource consumption by the machine-learning models (e.g., a number of operations, data movement between layers of the model, and so forth). The power manager 106 is thus configured in this example to utilize indications by the QoS parameters 120 and priority parameter 118 to determine a minimum amount of computational resources to be allocated to process the workload (e.g., from the compute array 110 to form the partition 112).

The power manager 106 is also configured to consider various other information as part of selecting a power-level setting for processing the digital image 204. An example of this is illustrated as operation data 218, which describes the operation of the hardware compute unit 108. The operation data 218, for instance, describes a power state (e.g., current power consumption), available resources, resources consumed by other partitions, partition sharing, temperature, active sessions, and so forth. In this way, the power manager 106 is also configured to leverage insight into the operation of the hardware compute unit 108 itself as part of selecting the power setting.

In the illustrated example, the power manager 106 is executed while preparing the machine-learning models, model closing, system power events, and internal refresh events. Otherwise, the power manager 106 is not executed (e.g., during inferences) to minimize scheduling overhead. The functionality of the power manager 106 is divided into a host scheduler 220 and a firmware scheduler 222. The host scheduler 220 is responsible for dispatch queue and partition management. The firmware scheduler 222 is responsible for priority dispatch and preemption.

The power manager 106 uses the priority parameter 118 and QoS parameters 120 received via the QoS API 210 and model complexity defined by the resource data 216 to determine the resources involved and power settings required for a given inference session. The power manager 106 also leverages operation data 218 describing resources utilized by other active sessions and system power states to determine an optimal power setting for the workload, e.g., as an active inference session.

In a scenario in which the priority parameter 118 is specified (e.g., “real time,” “priority-band,” or “best-effort”), real-time priority is higher than that of “priority-band,” which is higher than that of a “best-effort” priority (also referred to as “normal” or “non-real-time” priority). Examples of QoS parameters 120 include latency 212 (e.g., a deadline) and throughput 214 (e.g., frames-per-second

To schedule a real-time priority session, the power manager 106 locates the next available partition with sufficient computational resources, e.g., based on the QoS parameters 120, workload statistics, and/or operation data 218. Suppose the partition is assigned to a “best effort” session. In that case, the power manager 106 flushes queues associated with the partition, reconfigures the partition for this new session, and reschedules the original “best effort” session. In an instance in which a free partition is not available, model preparation fails because the specified QoS cannot be met.

For a “priority-band” priority session, the power manager 106 balances performance with power efficiency. In particular, the power manager 106 may locate the next free partition having sufficient computational resources or one assigned to a “best effort” session with sufficient computational resources. For example, in a low-power or battery-saver mode, the power manager 106 prefers a smaller partition size. In contrast, the power manager 106 prefers a larger partition size in a best-performance or better-performance mode. Similarly, in a low-power mode, the power manager 106 institutes partition sharing with other “best-effort” priority sessions.

For a “best-effort” priority session, the power manager 106 finds the next available partition according to a specified system power state. For example, the power manager 106 prefers a smaller partition size in a low-power or battery-saver mode. In contrast, the power manager 106 prefers a larger partition size in a best-performance or better-performance mode. In a priority-band performance mode, the power manager 106 biases towards performance and power efficiency. Similarly, in a low-power mode, the power manager 106 institutes partition sharing with other “best-effort” priority sessions.

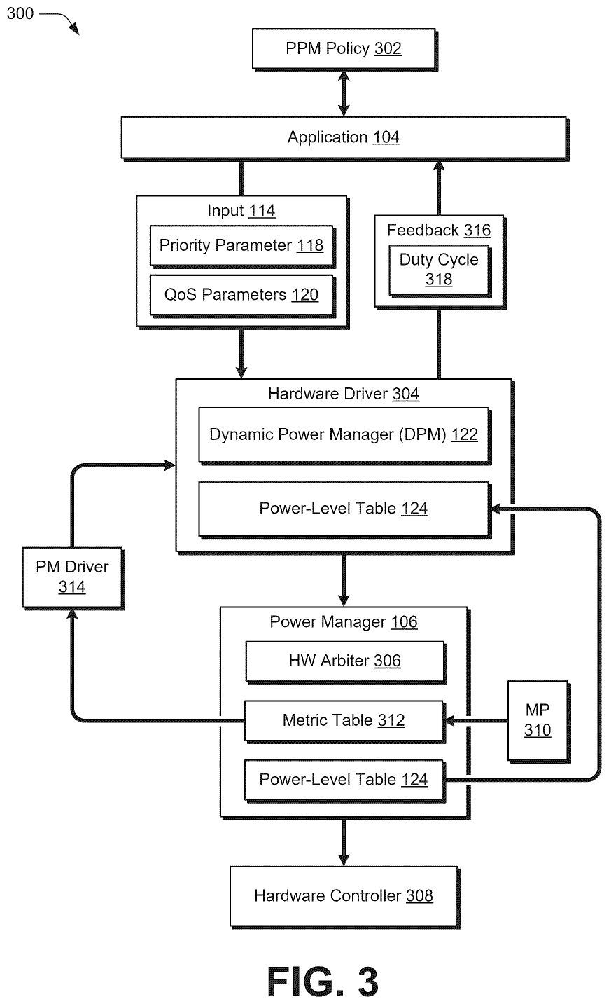

FIG. 3 is a block diagram of a non-limiting example 300 of a system showing the operation of a power manager 106 and a hardware driver 304 to implement QoS management for (real-time, priority-band, and best-effort) inference models using power management policies. In this example, frequency arbitration for application 104 is illustrated. In particular, the application 104 utilizes a machine-learning model to perform an AI workload.

The application 104 is configured to bi-directionally communicate a processor-power-management (PPM) policy 302 for the AI workload. The PPM policy 302 indicates a QoS profile for the processor or processor core (e.g., CPU) carrying out the AI workload.

As described above, the application 104 provides an input 114 to a hardware driver 304. For example, the hardware driver 304 manages the power (e.g., voltage) and clock frequency for the hardware compute unit 108 (e.g., an accelerator processing unit (APU)) that processes the AI workload. The input 114 includes the priority parameter 118 and QoS parameters 120 for the AI workload.

The hardware driver 304 includes the DPM 122 that provides dynamic power management for the hardware compute unit 108. The power-level table 124 is also included in the hardware driver 304. The power-level table 124 provides multiple potential power settings (e.g., pairs of a voltage and frequency) at which to operate the hardware compute unit 108 (e.g., the APU or other processing units). For example, the power settings of the power-level table 124 include operating frequencies of 2.0gigahertz (GHz), 1.8 GHz, 1.6 GHz, 1.0 GHz, 200 MHz, and so forth. Example voltages in the power-level table 124 range from 0.5 volts (V) to 1.3 V.

The hardware driver 304 is communicatively coupled to the power manager 106 and provides the priority parameter 118 associated with the AI workload to the hardware (HW) arbiter 306. Based on the priority state (e.g., real-time versus priority-band versus best-effort) indicated by the priority parameter 118, the HW arbiter 306 selects either a hard-minimum power setting (e.g., also referred to as a “hardmin” setting herein) or a soft-minimum power setting (e.g., also referred to as a “softmin” setting herein) operating state to provide to a hardware controller 308, which controls the power setting (e.g., operating frequency and voltage) of the hardware compute unit 108, other hardware compute units, or partitions thereof. In particular, a real-time priority is associated with or assigned the “hardmin” operating state that results in the QoS parameters 120 associated with a workload being satisfied, even at the expense of other workloads or applications via throttling. The “hardmin” operating state results in the workload being assigned a power setting within the power-level table 124 that satisfies the QoS parameters 120. Often, such workloads are assigned the lowest power setting within the power-level table 124 that satisfies the QoS parameters 120 to promote power efficiency. A priority-band or best-effort priority is associated with or assigned the “softmin” operating state. Under the “softmin” operating state, if the power setting determined by the QoS parameters 120 is lower than a power-mode-derived power setting, then the lower best-effort QoS-derived power setting is selected for the hardware compute unit 108 to save power. In contrast, if the power setting determined by the QoS parameters 120 is higher than a power-mode-derived power setting, then the power-mode-derived power setting is selected to satisfy the power-mode policy. If a workload does not specify any QoS parameters 120, then a default power-mode-derived power setting is used.

The power-level table 124 of the hardware driver 304 queries the power-level table 124 of the power manager 106. In at least one implementation, the power-level table 124 of the hardware driver 304 is a local hosted copy of at least a subset of the power-level table 124 of the power manager 106. This query is based on OPN. In addition, raising the selected power setting also results in the selection of higher fabric-clock (FCLK) and local (or bus) clock (LCLK) frequencies to provide optimal bandwidth and performance for the hardware compute unit 108. Similarly, the HCLK DPM state is linked to CLK of the MP 310, LCLK, and power state of the data fabric.

A management processor (MP) 310 provides inputs to a metric table 312, which indicates metrics associated with the hardware unit (e.g., a busy measurement, power measurement, and number of active columns). The MP 310 provides per-column PG/CG status data to the metric table 312 whenever there is a change in busy status (e.g., “idle”) in scratch registers for the busy calculation. The busy status within the metric table 312 is calculated based on per-column PG/CG status data from the MP 310. The power manager 106 reads the scratch registers in the MP 310, with each bit representing a column. If the bit is set, the corresponding column is one hundred percent busy. If the bit is not set, the corresponding column is zero percent busy. The MP 310 also provides vector instruction count for a power estimation algorithm of the metric table 312. A power manager (PM) driver 314 sends a hint to the hardware driver 304 to limit (e.g., cap) the power-level table 124 depending on a power-slider position or power source (e.g., AC versus DC power). For example, the power-mode hint, which includes a power-slider position or power source indication, may result in higher power settings within the power-level table 124 not being available to the application 104 or associated workloads. In this way, techniques and systems are described to extend resource (e.g., power) prioritization to both real-time and best-effort workloads while still employing power-saving policies via power-slider and power-source policies.

The hardware driver 304 also provides feedback 316 regarding duty cycle 318 to the application 104 based on the assigned power setting and/or power-mode policies. In particular, the feedback 316 includes an indication of the throttling or duty cycle percentage to the application 104.

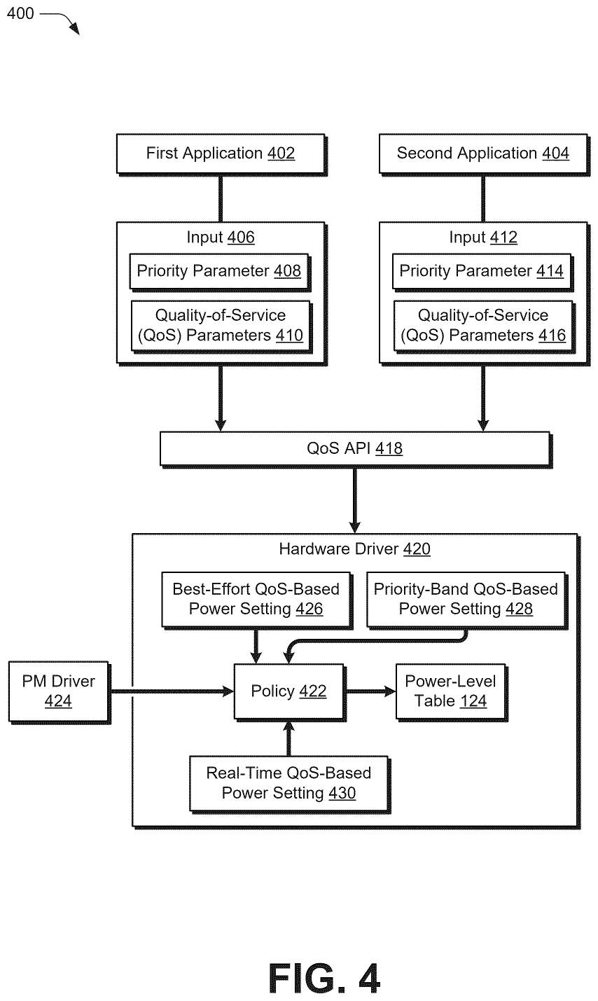

FIG. 4 is a block diagram of a non-limiting example block diagram 400 of a framework for QoS management for real-time, priority-band, and best-effort inference models (and other clients) using power management policies. In this example, resource guarantees are provided to ensure QoS specifications are satisfied for real-time, priority-band, and best-effort workloads. In particular, the block diagram 400 illustrates resource management for a first application 402 and second application 404 with inference or AI workloads.

The first application 402 provides an input 406 specifying a first priority parameter 408 and first QoS parameters 410 via a QoS API 418. In the illustrated example, the first priority parameter 408 specifies a real-time priority. The first QoS parameters 410 specify latency and throughput requirements for the workload of the first application 402. In some implementations, the first QoS parameters 410 also indicate a deadline or time for completing the inference workload.

The second application 404 provides an input 412 specifying a second priority parameter 414 and second QoS parameters 416 via the QoS API. In the illustrated example, the second priority parameter 414 specifies a normal or “best-effort” priority. The second QoS parameters 416 specify latency and throughput requirements for the workload of the second application 404.

The QoS API 418 is implemented in this example as part of a runtime that includes an artificial intelligence (AI) runtime and a runtime library. The runtime communicates with a hardware driver 420 having a solver, core, and memory storing precompiled machine-learning models and associated metadata, e.g., resource data. The hardware compute unit implements a power manager and includes a management thread.

The first application 402, for example, calls the QoS API 418 and provides the first priority parameter 408 as real-time and the first QoS parameters 410. The QoS API 418 provides these parameters to the hardware driver 420. As a result, a real-time QoS-based power setting 430 is applied to a policy 422 associated with the first application 402. In other implementations, if a priority parameter indicates a priority-band for a particular application, a priority-band QoS-based power setting 428 is applied to the policy associated with the application.

The second application 404 calls the QoS API 418 and provides the second priority parameter 414 as best-effort and the second QoS parameters 416. The QoS API 418 provides these parameters to the hardware driver 420. As a result, a best-effort QoS-based power setting 426 is applied to the policy 422 associated with the second application 404. A PM driver 424 also informs the policy 422 of potential power settings currently available for the hardware unit (e.g., the power-level table 124). In some implementations, the potential power settings depend on a current power-slider position and/or power source (e.g., AC versus DC). Policy 422 then assigns a particular power setting within the power-level table 124 to carry out the workloads of the first application 402 and the second application 404, respectively. In particular, the first application 402 (with real-time priority) is guaranteed power settings such that the first QoS parameters 410 are satisfied. In addition, resource prioritization is extended to the second application 404 (with best-effort priority and specified QoS parameters) to attempt to satisfy the second QoS parameters 416 as long as they do not contradict power-slider or power-source policies. If no QoS parameters are provided, the associated workload is assigned a power setting associated with the current power slider or power source policy.

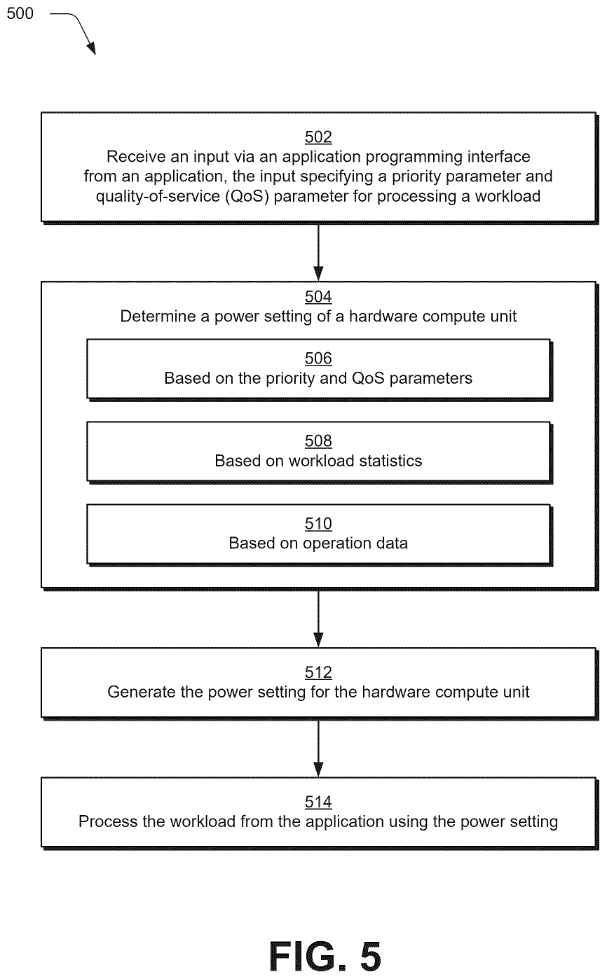

FIG. 5 depicts a procedure 500 for QoS management of inference models using power management policies. The procedure 500 is shown as operations (or actions) performed, but not necessarily limited to the order or combinations in which the operations are shown herein. Any one or more operations may be repeated, combined, or reorganized to provide other algorithms. In portions of the following discussion, reference may be made to the systems and components of FIGS. 1 through 4, reference to which is made by example. The algorithm is not limited to performance by the mentioned systems and components.

An input is received via an application programming interface from an application (block 502). The input specifies a priority parameter and QoS parameter for processing a workload associated with the application. For example, a power manager 106 receives the input 114, including the priority parameter 118 and the QoS parameter 120, via a QoS API 210.

A power setting (e.g., operating frequency and voltage) of a hardware compute unit is determined to process the workload (block 504). For example, the power setting is selected based on the priority parameter 118 (e.g., real-time, power-band, or best-effort) and the QoS parameters 120 (e.g., latency 212 or throughput 214) (block 506). In other implementations, the priority parameter 118 has multiple potential states or levels (e.g., a first, second, third, and fourth power setting) in descending or ascending order of priority. By way of another example, the power setting is also selected based on workload statistics (block 508), including the number of operations or data movement. By way of a further example, the operating frequency is selected based on operation data 218 (block 510), e.g., describing the operation of partitions and partition availability.

The power setting is generated or set for the hardware compute unit or a portion thereof (block 512). For example, the power manager or hardware driver sets the voltage and frequency of the clock signal needed to generate the operating frequency.

The workload from the application is processed using the hardware compute unit operating at the selected power setting (block 514). By way of example, the workload includes execution of a precompiled machine-learning model 206 via a respective partition 112 to process a digital image 204, e.g., for object recognition. A variety of other examples are also contemplated.

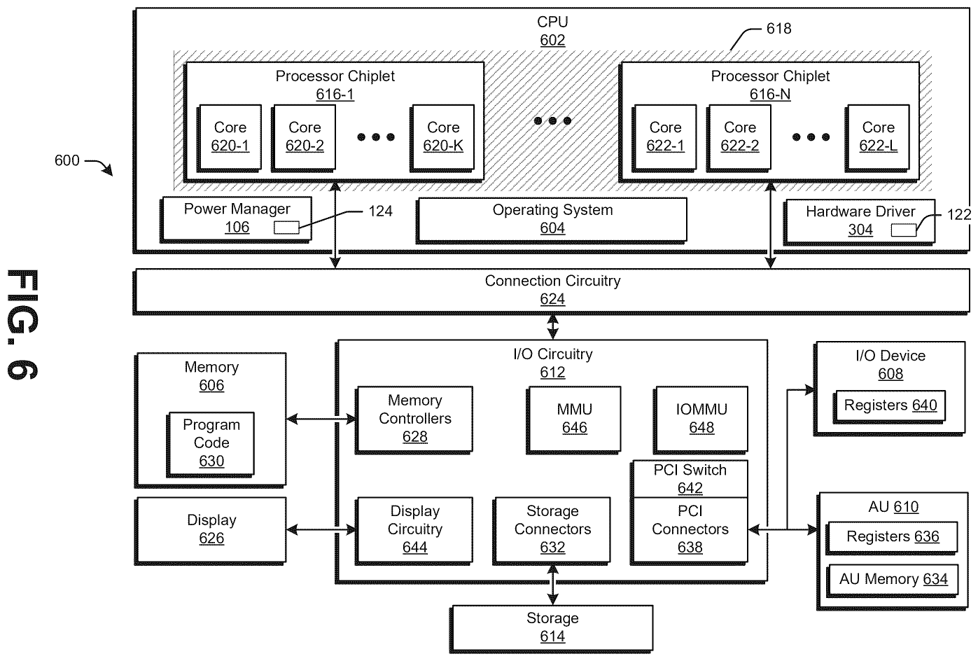

FIG. 6 is a block diagram of a processing system configured to execute one or more applications in accordance with one or more implementations.

In particular, FIG. 6 includes a processing system 600 configured to execute one or more applications (e.g., application 104 of FIG. 1), such as computing applications (e.g., machine-learning applications, neural network applications, high-performance computing applications, databasing applications, gaming applications), graphics applications, and the like. Examples of devices (e.g., the device 102 of FIG. 1) in which the processing system 600 is implemented include but are not limited to a server computer, personal computer (e.g., desktop or tower computer), smartphone or another wireless phone, tablet or phablet computer, notebook computer, laptop computer, wearable device (e.g., smartwatch, augmented reality headset or device, virtual reality headset or device), entertainment device (e.g., gaming console, portable gaming device, streaming media player, digital video recorder, music or another audio playback device, television, set-top box), Internet of Things (IoT) device, automotive computer or computer for another type of vehicle, networking device, medical device or system, and other computing devices or systems.

In the illustrated example, the processing system 600 includes a central processing unit (CPU) 602. In one or more implementations, the CPU 602 is configured to run an operating system (OS) 604 that manages the execution of applications. For example, the OS 604 is configured to schedule the execution of tasks (e.g., instructions) for applications, allocate portions of resources (e.g., system memory 606, CPU 602, input/output (I/O) device 608, accelerator unit (AU) 610, storage 614) for the execution of tasks for the applications, provide an interface to I/O devices (e.g., I/O device 608) for the applications, or any combination thereof.

In this example, the power manager 106 with the power-level table 124 and the hardware driver 304 with the dynamic power manager 122 are depicted as part of CPU 602. In other implementations, the power manager 106 also includes the dynamic power manager 122 and the hardware driver 304 also includes the power-level table 124. In variations, the power manager 106 or the hardware driver 304 are included in and/or implemented by one or more different components of the processing system 600, such as the AU 610 or the I/O circuitry 612.

The CPU 602 includes one or more processor chiplets 616, which are communicatively coupled by a data fabric 618 in one or more implementations. Each processor chiplet 616, for example, includes one or more processor cores 620, 622 configured to execute one or more series of instructions concurrently, also referred to herein as “threads”, for an application. Further, the data fabric 618 communicatively couples each processor chiplet 616-N of the CPU 602 such that each processor core (e.g., processor cores 620) of a first processor chiplet (e.g., 616-1) is communicatively coupled to each processor core (e.g., processor cores 622) of one or more other processor chiplets 616.

Though the example embodiment in FIG. 6 shows a first processor chiplet (616-1) having three processor cores (620-1, 620-2, 620-K) representing a K number of processor cores 622 and a second processor chiplet (616-N) having three processor cores (e.g., 622-1, 622-2, 622-L) representing an L number of processor cores 622, in other implementations (L being an integer number greater than or equal to one), each processor chiplet 616 may have any number of processor cores 620, 622. For example, each processor chiplet 616 can have the same number of processor cores 620, 622 as one or more other processor chiplets 616, a different number of processor cores 620, 622 as one or more other processor chiplets 616, or both.

Examples of connections that are usable to implement the data fabric 618 include but are not limited to buses (e.g., a data bus, a system, an address bus), interconnects, memory channels, and silicon vias, traces, and planes. Other example connections include optical connections, fiber optic connections, and/or connections or links based on quantum entanglement.

Additionally, within the processing system 600, the CPU 602 is communicatively coupled to an I/O circuitry 612 by a connection circuitry 624. For example, each processor chiplet 616 of the CPU 602 is communicatively coupled to the I/O circuitry 612 by the connection circuitry 624. The connection circuitry 624 includes, for example, one or more data fabrics, buses, buffers, queues, and the like. The I/O circuitry 612 is configured to facilitate communications between two or more components of the processing system 600 such as between the CPU 602, system memory 606, display 626, universal serial bus (USB) devices, peripheral component interconnect (PCI) devices (e.g., I/O device 608, AU 610), storage 614, and the like.

As an example, system memory 606 includes any combination of one or more volatile memories and/or one or more non-volatile memories, examples of which include dynamic random-access memory (DRAM), static random-access memory (SRAM), non-volatile RAM, and the like. To manage access to the system memory 606 by CPU 602, the I/O device 608, the AU 610, and/or any other components, the I/O circuitry 612 includes one or more memory controllers 628. The memory controllers 628, for example, include circuitry configured to manage and fulfill memory access requests issued from the CPU 602, the I/O device 608, the AU 610, or any combination thereof. Examples of such requests include read requests, write requests, fetch requests, pre-fetch requests, or any combination thereof. That is to say, the memory controllers 628 are configured to manage access to the data stored at one or more memory addresses within the system memory 606, such as by CPU 602, I/O device 608, and/or AU 610.

When an application is to be executed by processing system 600, the OS 604 running on the CPU 602 is configured to load at least a portion of program code 630 (e.g., an executable file) associated with the application from, for example, a storage 614 into system memory 606. This storage 614, for example, includes a non-volatile storage such as a flash memory, solid-state memory, hard disk, optical disc, or the like configured to store program code 630 for one or more applications.

To facilitate communication between the storage 614 and other components of processing system 600, the I/O circuitry 612 includes one or more storage connectors 632 (e.g., universal serial bus (USB) connectors, serial AT attachment (SATA) connectors, PCI Express (PCIe) connectors) configured to communicatively couple storage 614 to the I/O circuitry 612 such that I/O circuitry 612 is capable of routing signals to and from the storage 614 to one or more other components of the processing system 600.

In association with executing an application, in one or more scenarios, the CPU 602 is configured to issue one or more instructions (e.g., threads) to be executed for an application to the AU 610. The AU 610 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 610 includes one or more compute units that concurrently execute one or more threads of an application and store data resulting from the execution of these threads in AU memory 634. This AU memory 634, for example, includes any combination of one or more volatile memories and/or non-volatile memories, examples of which include caches, video RAM (VRAM), or the like. In one or more implementations, these compute units are also configured to execute these threads based on the data stored in one or more physical registers 636 of the AU 610.

To facilitate communication between the AU 610 and one or more other components of processing system 600, the I/O circuitry 612 includes or is otherwise connected to one or more connectors, such as PCI connectors 638 (e.g., PCIe connectors) each including circuitry configured to communicatively couple the AU 610 to the I/O circuitry such that the I/O circuitry 612 is capable of routing signals to and from the AU 610 to one or more other components of the processing system 600. Further, the PCIe connectors 638 are configured to communicatively couple the I/O device 608 to the I/O circuitry 612 such that the I/O circuitry 612 is capable of routing signals to and from the I/O device 608 to one or more other components of the processing system 600.

By way of example and not limitation, the I/O device 608 includes one or more camera systems (e.g., the digital camera 202 of FIG. 2), keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 608 is configured to execute one or more operations, tasks, instructions, or any combination thereof based on one or more physical registers 640 of the I/O device 608. In one or more implementations, such physical registers 640 are configured to maintain data (e.g., operands, instructions, values, variables) indicating one or more operations, tasks, or instructions to be performed by the I/O device 608.

To manage communication between components of the processing system 600 (e.g., AU 610, I/O device 608) that are connected to PCI connectors 638, and one or more other components of the processing system 600, the I/O circuitry 612 includes PCI switch 642. The PCI switch 642, for example, includes circuitry configured to route packets to and from the components of the processing system 600 connected to the PCI connectors 638 as well as to the other components of the processing system 600. As an example, based on address data indicated in a packet received from a first component (e.g., CPU 602), the PCI switch 642 routes the packet to a corresponding component (e.g., AU 610) connected to the PCI connectors 638.

Based on the processing system 600 executing a graphics application, for instance, the CPU 602, the AU 610, or both are configured to execute one or more instructions (e.g., draw calls) such that a scene including one or more graphics objects is rendered. After rendering such a scene, the processing system 600 stores the scene in the storage 614, displays the scene on the display 626, or both. The display 626, for example, includes a cathode-ray tube (CRT) display, liquid crystal display (LCD), light emitting diode (LED) display, organic light emitting diode (OLED) display, or any combination thereof. To enable the processing system 600 to display a scene on the display 626, the I/O circuitry 612 includes display circuitry 644. The display circuitry 644, for example, includes high-definition multimedia interface (HDMI) connectors, DisplayPort connectors, digital visual interface (DVI) connectors, USB connectors, and the like, each including circuitry configured to communicatively couple the display 626 to the I/O circuitry 612. Additionally or alternatively, the display circuitry 644 includes circuitry configured to manage the display of one or more scenes on the display 626 such as display controllers, buffers, memory, or any combination thereof.

Further, the CPU 602, the AU 610, or both are configured to concurrently run one or more virtual machines (VMs), which are each configured to execute one or more corresponding applications. To manage communications between such VMs and the underlying resources of the processing system 600, such as any one or more components of processing system 600, including the CPU 602, the I/O device 608, the AU 610, and the system memory 606, the I/O circuitry 612 includes memory management unit (MMU) 646 and input-output memory management unit (IOMMU) 648. The MMU 646 includes, for example, circuitry configured to manage memory requests, such as from the CPU 602 to the system memory 606. For example, the MMU 646 is configured to handle memory requests issued from the CPU 602 and associated with a VM running on the CPU 602. These memory requests, for example, request access to read, write, fetch, or pre-fetch data residing at one or more virtual addresses (e.g., guest virtual addresses) each indicating one or more portions (e.g., physical memory addresses) of the system memory 606. Based on receiving a memory request from the CPU 602, the MMU 646 is configured to translate the virtual address indicated in the memory request to a physical address in the system memory 606 and to fulfill the request. The IOMMU 648 includes, for example, circuitry configured to manage memory requests (memory-mapped I/O (MMIO) requests) from the CPU 602 to the I/O device 608, the AU 610, or both, and to manage memory requests (direct memory access (DMA) requests) from the I/O device 608 or the AU 610 to the system memory 606. For example, to access the registers 640 of the I/O device 608, the registers 636 of the AU 610, and/or the AU memory 634, the CPU 602 issues one or more MMIO requests. Such MMIO requests each request access to read, write, fetch, or pre-fetch data residing at one or more virtual addresses (e.g., guest virtual addresses) which each represent at least a portion of the registers 640 of the I/O device 608, the registers 636 of the AU 610, or the AU memory 634, respectively. As another example, to access the system memory 606 without using the CPU 602, the I/O device 608, the AU 610, or both are configured to issue one or more DMA requests. Such DMA requests each request access to read, write, fetch, or pre-fetch data residing at one or more virtual addresses (e.g., device virtual addresses) which each represent at least a portion of the system memory 606. Based on receiving an MMIO request or DMA request, the IOMMU 648 is configured to translate the virtual address indicated in the MMIO or DMA request to a physical address and fulfill the request.

In variations, the processing system 600 can include any combination of the components depicted and described. For example, in at least one variation, the processing system 600 does not include one or more of the components depicted and described in relation to FIG. 6. Additionally or alternatively, in at least one variation, the processing system 600 includes additional and/or different components from those depicted. The 600 is configurable in a variety of ways with different combinations of components in accordance with the described techniques.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the application 104, power manager 106, and hardware compute unit 108) are implemented in any of a variety of different manners such as hardware circuitry, software or firmware executing on a programmable processor, or any combination of two or more of hardware, software, and firmware. The methods provided are implemented in a variety of devices, such as a processor or processor core. Suitable processors include, by way of example, a special-purpose processor, inference processing unit, accelerated processing unit, digital signal processor (DSP), neural network engine (NNE), graphics processing unit (GPU), parallel accelerated processor, multiple microprocessors, one or more microprocessors in association with DSP cores, controllers, microcontrollers, Application Specific Integrated Circuits (ASICs), Field Programmable Gate Arrays (FPGAs) circuits, other types of integrated circuits (ICs), and/or state machines.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include read-only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A device comprising:
a power manager configured to:
expose an application programming interface to an application to specify a priority parameter and a quality-of-service (QoS) parameter for processing a workload; and
configure a hardware compute unit of the device to process the workload at a first power setting among multiple power settings based at least in part on the priority parameter and the QoS parameter.

2. The device of claim 1, wherein the power manager is further configured to:
in response to the priority parameter indicating a real-time priority and the QoS parameter specifying a latency or throughput for the workload, assign a hard-minimum power setting associated with the workload that ensures the QoS parameter is satisfied; or
in response to the priority parameter indicating a best-effort priority, the QoS parameter specifying a latency or throughput for the workload, and a power-mode setting being satisfied by the hardware compute unit, assign a soft-minimum power setting associated with the workload that ensures the QoS parameter is satisfied.

3. The device of claim 2, wherein the power-mode setting is based on:
whether the device is powered by alternating-current (AC) power or direct-current (DC) power; or
a power-slider position for the hardware compute unit, the power-slider position including at least two of a best power efficiency setting, one or more balanced power efficiency and performance settings, or a best performance setting.

4. The device of claim 3, wherein the power manager is further configured to throttle other hardware compute units of the device in response to the power setting selected to satisfy the QoS parameter under the hard-minimum power setting consuming more power than a potential power setting selected based on the power-mode setting.

5. The device of claim 3, wherein the power manager is further configured to throttle the hardware compute unit in response to the power setting selected to satisfy the QoS parameter under the soft-minimum power setting consuming more power than a potential power setting selected based on the power-mode setting.

6. The device of claim 2, wherein the power manager is further configured to, in response to the application not specifying the QoS parameter, assign no minimum power setting associated with the workload and determine the first power setting based on the power-mode setting.

7. The device of claim 1, wherein the power manager is further configured to receive operation data that describes operation characteristics of the hardware compute unit and determine the first power setting based at least in part on the priority parameter, the QoS parameter, and the operation data.

8. A method comprising:
receiving an input via an application programming interface (API) from an application, the input specifying a priority parameter for processing a workload associated with the application;
selecting, based at least in part on the priority parameter, a first power setting from among multiple power settings to process the workload, each power setting of the multiple power settings identifying a voltage and a frequency at which to operate a hardware compute unit; and
processing the workload from the application by the hardware compute unit at the first power setting.

9. The method of claim 8, wherein the priority parameter indicates the workload has a real-time priority, priority-band, or best-effort priority.

10. The method of claim 9, wherein the method further comprises:
in response to the priority parameter indicating the real-time priority and the input also specifying a quality-of-service (QoS) parameter for the workload, selecting a second power setting from among the multiple power settings to process the workload that satisfies the QoS parameter;
in response to the priority parameter indicating the best-effort priority and the input also specifying the QoS parameter for the workload, selecting a third power setting to process the workload that satisfies the QoS parameter or a power mode of the hardware compute unit; or
in response to the input not specifying the QoS parameter for the workload, selecting a fourth power setting that satisfies the power mode.

11. The method of claim 10, wherein:
in response to a power-mode-based power setting consuming more power than a QoS-based power setting, the QoS-based power setting is selected as the third power setting; or
in response to the QoS-based power setting consuming more power than the power-mode-based power setting, the power-mode-based power setting is selected as the third power setting.

12. The method of claim 10, wherein:
the multiple power settings are arranged in a power-level table by descending amounts of power consumption per power setting; and
potential power settings available in the power-level table are determined at least in part by the power mode of the hardware compute unit.

13. The method of claim 8, wherein:
the method further comprises receiving workload statistics describing the workload; and
selecting the first power setting is based at least in part on the priority parameter and the workload statistics.

14. The method of claim 13, wherein the workload statistics specify a number of operations or amount of data movement.

15. The method of claim 13, wherein the workload statistics are determined based on prior knowledge of processing the workload.

16. The method of claim 8, wherein the workload includes execution of a machine-learning model selected from a plurality of precompiled machine-learning models.

17. The method of claim 8, wherein:
the method further comprises receiving operation data that describes operating characteristics of the hardware compute unit; and
selecting the first power setting is based at least in part on the priority parameter and the operation data.

18. The method of claim 17, wherein the operation data comprises operation characteristics of another partition of the hardware compute unit.

19. A method comprising:
receiving an input from an application that specifies a priority parameter, a quality-of-service (QoS) parameter, and workload statistics for processing a workload;
selecting a power setting of a hardware compute unit to process the workload, the power setting determined to minimize power consumption in processing the workload and based at least in part on the workload statistics, the priority parameter, and the QoS parameter;
generating a partition in the hardware compute unit based on the power setting; and
processing the workload from the application using the generated partition by the hardware compute unit.

20. The method of claim 19, wherein the method further comprises:
in response to the priority parameter indicating a real-time priority and the QoS parameter being specified, selecting the power setting to ensure satisfaction of the QoS parameter;
in response to the priority parameter indicating a best-effort priority and the QoS parameter being specified, selecting the power setting to ensure satisfaction of the QoS parameter or compliance with a power-mode setting associated with the hardware compute unit; or
in response to the QoS parameter not being specified, selecting the power setting to ensure compliance with the power-mode setting.
